(19) United States
(12) Patent Application Publication
(10) Pub. No.: US 2010/0001005 A1
(43) Pub. Date: Jan. 7, 2010

(54) Composite Cryogenic Tank with Thermal Strain Reducer Coating

(75) Inventor: Keith Chong, Placentia, CA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 12/166,299

(22) Filed: Jul. 1, 2008

(51) Int. Cl. F17C 13/00

(52) U.S. Cl. 220/560.05; 29/527.1

(57) ABSTRACT

A cryogenic fuel tank includes a composite tank wall enclosing a tank interior and having a tank wall surface, at least one coating provided on the tank wall surface, a foam insulation layer provided on the at least one coating and a plurality of stiffening fibers provided in one of the at least one coating and the foam insulation layer. A method of providing a thermal strain reducer coating on a composite structure is also disclosed.

### TECHNICAL FIELD

The disclosure relates to coatings for composite structures. More particularly, the disclosure relates to a composite cryogenic tank having a chopped fiber and polyurethane thermal strain reducer coating.

### BACKGROUND

In some applications, it may be necessary to provide a thermal strain reducing coating between a first structure and a second structure having different coefficients of thermal expansion (CTE) to reduce thermal strain between the structures. For example, in some applications composite cryogenics may require a thermal strain reducing coating between the composite Cryogenic Tank surface and the foam insulation layer. In some applications, it may be desirable for the thermal strain reducing coating to both act as a thermal strain reducer between the foam insulation layer and the composite cryogenic tank wall and enhance adhesion of the foam insulation layer to the polyurethane coating.

### SUMMARY

The disclosure is generally directed to a cryogenic fuel tank. An illustrative embodiment of the cryogenic fuel tank includes a composite tank wall enclosing a tank interior and having a tank wall surface, at least one coating provided on the tank wall surface, a foam insulation layer provided on at least one coating and a plurality of stiffening fibers provided in one of the at least one coating and the foam insulation layer.

The disclosure is further generally directed to a method of providing a thermal strain reducer coating on a composite structure. An illustrative embodiment of the method includes providing a composite structure, providing at least one coating on the composite structure, providing a foam insulation layer on the at least one coating and providing a plurality of stiffening fibers in one of the at least one coating and the foam insulation layer.

### BRIEF DESCRIPTION OF THE ILLUSTRATIONS

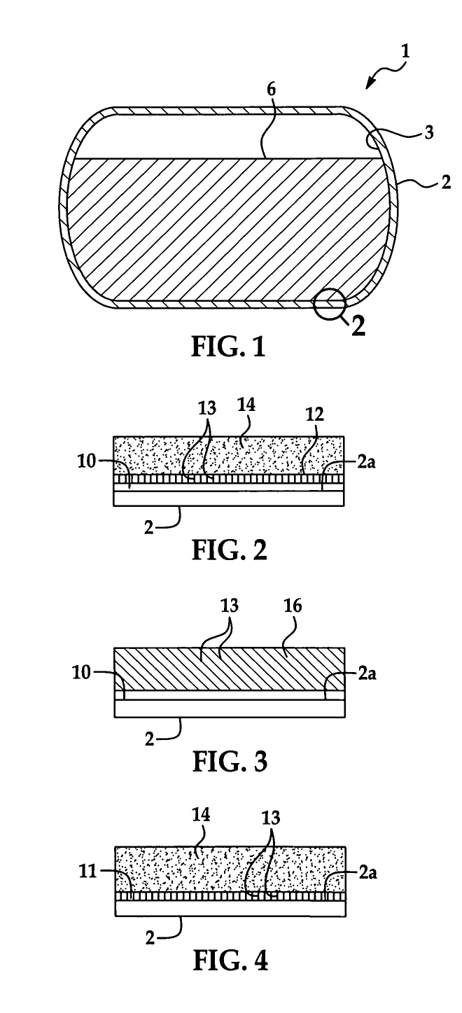

FIG. 1 is a cross-sectional view of an illustrative embodiment of the composite cryogenic tank.

FIG. 2 is an enlarged sectional view, taken along section line 2 in FIG. 1, illustrating a fiber layer interposed between a foam insulation layer and a polymeric coating provided on a tank wall surface of the composite cryogenic tank.

FIG. 3 is an enlarged sectional view, also taken along section line 2 in FIG. 1, of an alternative illustrative embodiment of the composite cryogenic tank, with a blended fiber/foam insulation layer provided on a polymeric coating on the tank wall surface of the composite cryogenic tank.

FIG. 4 is an enlarged sectional view, taken along section line 2 in FIG. 1, of another alternative illustrative embodiment of the composite cryogenic tank, with a polymeric fiber layer interposed between a foam insulation layer and the tank wall surface of the composite cryogenic tank.

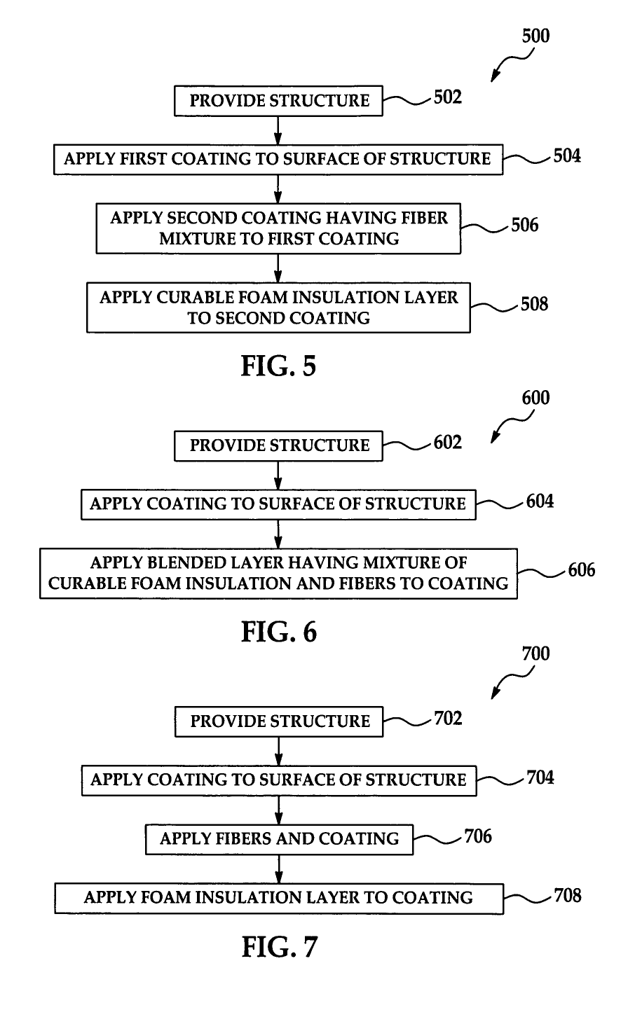

FIG. 5 is a flow diagram illustrating an illustrative embodiment of a method of providing a fiber layer as a thermal strain reducer coating on a polymeric coating provided on a surface of a composite structure.

FIG. 6 is a flow diagram illustrating an illustrative embodiment of a method of providing a foam insulation layer as a thermal strain reducer coating on a polymeric coating provided on a surface of a composite structure.

FIG. 7 is a flow diagram illustrating an illustrative embodiment of a method of providing a polymeric fiber layer as a thermal strain reducer coating on a composite surface.

### DETAILED DESCRIPTION

Referring initially to FIGS. 1 and 2, an illustrative embodiment of the composite cryogenic tank with thermal strain reducer coating, hereinafter cryogenic tank, is generally indicated by reference numeral 1 in FIG. 1. The cryogenic tank 1 may include a composite tank wall 2 which encloses a tank interior 3. The tank interior 3 may be adapted to contain a liquefied gas 6 such as liquefied natural gas or liquid hydrogen, for example and without limitation. Conduits (not shown) may communicate with the tank interior 3 to facilitate placement of the liquefied gas 6 into and removal of the liquefied gas 6 from the tank interior 3, as is known by those skilled in the art.

As shown in FIG. 2, the tank wall 2 of the cryogenic tank 1 has a tank wall surface 2a which may be an exterior surface of the tank wall 2. A polymeric coating 10, which may be a polyurethane coating, for example and without limitation, may be robotically sprayed on the tank wall surface 2a. A fiber layer 12 may be provided on the polymeric coating 10. The fiber layer 12 may include multiple chopped stiffening fibers 13 which are embedded in a polymeric matrix. The stiffening fibers 13 may be high-modulus fibers including polyurethane fibers, nomex fibers, aramid fibers, glass fibers, graphite fibers, ceramic fibers or organic fibers such as KEVLAR, for example and without limitation. An insulation layer 14 may be provided on the fiber layer 12. The insulation layer 14 may be a spray-on foam insulation (SOFI) layer, for example and without limitation. In some applications, the fiber layer 12 may be robotically sprayed onto the polymeric coating 10 and the foam insulation layer 14 may be robotically sprayed onto the fiber layer 12.

During use of the composite cryogenic tank 1, the polymeric coating 10 and the fiber layer 12 may act in combination as a thermal strain reducer between the foam insulation layer 14 and the tank wall 2 under cryogenic conditions. The stiffening fibers 13 in the fiber layer 12 may mitigate and/or reduce the effects of the CTE (coefficient of thermal expansion) difference between the foam insulation layer 14 and the tank wall 2 under cryogenic conditions. This may prevent delamination of the foam insulation layer 14 from the tank wall 2. Additionally, the polymeric coating 10 and the fiber layer 12 may enhance adhesion of the foam insulation layer 14 to the tank wall surface 2a of the tank wall 2. Robotic methods of applying the fiber layer 12, polymeric coating 10 and the foam insulation layer 14 may potentially eliminate the formation of air pockets in the layers.

Referring next to FIGS. 1 and 3, in some embodiments a blended fiber/foam insulation layer 16 may be provided on the polymeric coating 10 such as by robotic spraying, for example. The blended fiber/foam insulation layer 16 may include stiffening fibers 13 embedded in an insulating foam matrix. The combination of the stiffening fibers 13 and the polymeric coating 10 may act as a thermal strain reducer between the blended fiber/foam insulation layer 16 and the tank wall 2 under cryogenic conditions and may enhance adhesion of the blended fiber/foam insulation layer 16 to the tank wall 2.

Referring next to FIGS. 1 and 4, in some embodiments a polymeric fiber layer 11 may be provided on the tank wall surface 2a of the tank wall 2. The polymeric fiber layer 11 may include stiffening fibers 13 embedded in a polymeric matrix such as polyurethane, for example and without limitation. In some embodiments, the polymeric fiber layer 11 may be a polyurethane tiecoat. An insulation layer 14, which may be a spray-on foam insulation (SOFI) layer, for example and without limitation, may be provided on the polymeric fiber layer 11. The polymeric fiber layer 11 may act as a thermal strain reducer between the foam insulation layer 14 and the tank wall 2 under cryogenic conditions and may enhance adhesion of the foam insulation layer 14 to the tank wall 2.

In an exemplary method of application, the polymeric fiber layer 11 may be robotically applied to the tank wall surface 2a of the tank wall 2. To improve the adhesion and/or further reduce the CTE mismatch tension between the foam insulation layer 14 and the tank wall 2, chopped stiffening fibers 13 may be robotically sprayed onto the partially-cured or tacky polymeric fiber layer 11. After curing of the polymeric fiber layer 11, the foam insulation layer 14 may be sprayed onto the polymeric fiber layer 11.

Referring next to FIG. 5, a flow diagram 500 illustrating an illustrative embodiment of a method of providing a fiber layer as a thermal strain reducer coating on a polymeric coating provided on a surface of a composite structure is shown. In block 502, a composite structure is provided. In block 504, a first coating is applied to a surface of the composite structure. In block 506, a second coating having a fiber mixture is applied to the first coating. In block 508, a curable foam insulation layer is applied to the second coating.

Referring next to FIG. 6, a flow diagram 600 illustrating an illustrative embodiment of a method of providing a foam insulation layer as a thermal strain reducer coating on a polymeric coating provided on a surface of a composite structure is shown. In block 602, a composite structure is provided. In block 604, a coating is applied to the surface of the composite structure. In block 606, a blended layer having a mixture of curable foam insulation and fibers is applied to the coating.

Referring next to FIG. 7, a flow diagram 700 illustrating an illustrative embodiment of a method of providing a polymeric fiber layer as a thermal strain reducer coating on a composite surface is shown. In block 702, a composite structure is provided. In block 704, a coating is applied to a surface of the composite structure. In block 706, fibers are applied to the coating. In block 708, a foam insulation layer is applied to the coating.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A cryogenic fuel tank, comprising:
a composite tank wall enclosing a tank interior and having a tank wall surface;
at least one coating provided on said tank wall surface;
a foam insulation layer provided on said at least one coating; and
a plurality of stiffening fibers provided in one of said at least one coating and said foam insulation layer.

2. The cryogenic fuel tank of claim 1 wherein said at least one coating comprises a polymeric coating provided on said tank wall surface and a fiber layer provided on said polymeric coating, and wherein said foam insulation layer is provided on said fiber layer and said plurality of stiffening fibers is provided in said fiber layer.

3. The cryogenic fuel tank of claim 2 wherein said polymeric coating comprises polyurethane.

4. The cryogenic fuel tank of claim 1 wherein said plurality of stiffening fibers is polyurethane fibers, nomex fibers, aramid fibers, glass fibers, graphite fibers, ceramic fibers or organic fibers.

5. The cryogenic fuel tank of claim 1 wherein said foam insulation layer comprises a spray-on foam insulation layer.

6. The cryogenic fuel tank of claim 1 wherein said at least one coating comprises a polymeric coating provided on said tank wall surface and said foam insulation layer is provided on said polymeric coating, and wherein said plurality of stiffening fibers is provided in said polymeric coating.

7. The cryogenic fuel tank of claim 6 wherein said polymeric coating comprises polyurethane.

8. The cryogenic fuel tank of claim 1 wherein said at least one coating comprises a polymeric coating provided on said tank wall surface and said foam insulation layer is provided on said polymeric coating, and wherein said plurality of stiffening fibers is provided in said foam insulation layer.

9. A method of providing a thermal strain reducer coating on a composite structure, comprising:
providing a composite structure;
providing at least one coating on said composite structure;
providing a foam insulation layer on said at least one coating; and
providing a plurality of stiffening fibers in one of said at least one coating and said foam insulation layer.

10. The method of claim 9 wherein said providing at least one coating on said composite structure comprises providing a polymeric coating on said composite structure and a fiber layer on said polymeric coating, and wherein said providing a plurality of stiffening fibers in one of said at least one coating and said foam insulation layer comprises providing a plurality of stiffening fibers in said fiber layer.

11. The method of claim 10 wherein said providing a polymeric coating on said composite structure comprises providing a polyurethane coating on said composite structure.

12. The method of claim 9 wherein said providing a plurality of stiffening fibers in one of said at least one coating and said foam insulation layer comprises providing a plurality of polyurethane fibers, nomex fibers, aramid fibers, glass fibers, graphite fibers, ceramic fibers or organic fibers in one of said at least one coating and said foam insulation layer.

13. The method of claim 9 wherein said providing a foam insulation layer on said at least one coating comprises spraying a foam insulation layer on said at least one coating.

14. The method of claim 9 wherein said providing at least one coating on said composite structure comprises providing a polymeric coating on said composite structure and wherein said providing a plurality of stiffening fibers in one of said at least one coating and said foam insulation layer comprises providing a plurality of stiffening fibers in said foam insulation layer.

15. The method of claim 9 wherein said providing a composite structure comprises providing a composite cryogenic tank.

16. A method of providing a thermal strain reducer coating on a composite structure, comprising:
providing a composite structure;
providing a polymeric fiber layer having a plurality of stiffening fibers on said composite structure; and
providing a foam insulation layer on said polymeric fiber layer.

17. The method of claim 16 wherein said providing a polymeric fiber layer on said composite structure comprises providing a polyurethane fiber layer on said composite structure.

18. The method of claim 16 wherein said providing a polymeric fiber layer having a plurality of stiffening fibers on said composite structure comprises providing a polymeric fiber layer having a plurality of polyurethane fibers, nomex fibers, aramid fibers, glass fibers, graphite fibers, ceramic fibers or organic fibers on said composite structure.

19. The method of claim 16 wherein said providing a foam insulation layer on said polymeric fiber layer comprises spraying a foam insulation layer on said polymeric fiber layer.

20. The method of claim 16 wherein said providing a composite structure comprises providing a composite cryogenic tank.
